(19) United States
(12) Patent Application Publication
(10) Pub. No.: US 2023/0029461 A1
(43) Pub. Date: Feb. 2, 2023

(54) ADAPTABLE HANDLEBAR LIGHTS WITH TURN ACTUATION

(71) Applicant: Daniel Ebrahemi, San Carlos, CA (US)

(72) Inventor: Daniel Ebrahemi, San Carlos, CA (US)

(21) Appl. No.: 17/840,962

(22) Filed: Jun. 15, 2022

Related U.S. Application Data
(60) Provisional application No. 63/227,907, filed on Jul. 30, 2021.

(51) Int. Cl. B62J 6/015; B62J 6/057; B62J 45/20; H05B 47/105; H05B 47/19; F21S 41/141; B62J 6/028; B62J 6/045

(52) U.S. Cl. CPC B62J 6/015; B62J 6/057; B62J 45/20; H05B 47/105; H05B 47/19; F21S 41/141; B62J 6/028; B62J 6/045; F21W 2107/13

(57) ABSTRACT

A bicycle including a handlebar attached to a frame at substantially a midpoint and a seat post, a plurality of light sources normally disposed to project light in either of a first, second or third forward direction, said plurality of light sources controlled by a microcomputer which employs a sensor to monitor the immediate position of either the handlebar with respect to the frame or the orientation of the bicycle with respect to the horizontal, and which selects the appropriate light source to be illuminated to project light in the most preferred direction to illuminate the anticipated path of the bicycle to improve visibility and safety during operation, particularly under low ambient light conditions, and wherein the microcomputer activates one or more front or rear turn signals, and brake lights in response to movement of the bicycle, handlebars or a manual signal.

### PRIORITY

This patent application claims the benefit of co-pending provisional application 63/227,907 filed Jul. 30, 2021, by the same inventor and is incorporated in its entirety as if fully set forth herein.

### TECHNICAL FIELD

This patent involves bicycle electronic lights and bicycle turn signals, in the field of transportation and recreation.

### BACKGROUND

Bicycle lights and turn signals are both useful at night and daytime to allow the rider to be visible to others, improve illumination of the anticipated path of the bicycle, and thus increase their safety and lower their risk of injury during operation of the bicycle.

### SUMMARY

Disclosed herein is a bicycle including a handlebar attached to a riser attached to a frame at substantially a midpoint. There is also a first set or plurality of light sources attached either to the riser or on one or both sides of the handlebar and operable to normally project light in a first forward direction. One or more of the light sources may also operate as a front turn signal on the appropriate side of the handlebar, optionally including a second plurality of light sources attached to a seat post and facing rearward to provide safety lighting and also to operate as a rear turn signal. The plurality of light sources is controlled by a microcomputer or microcontroller employing one or more sensors to monitor the immediate position of either the handlebar with respect to the frame or the orientation of the bicycle with respect to the horizontal, the microcomputer controlling one or a plurality of LED drivers to activate one or more of the light sources to project light in either of a first, second or third forward direction depending on the sensor input, to best illuminate the anticipated path of the bicycle during operation to improve visibility and safety, particularly under low ambient light conditions.

During a turning operation to the right, one or a plurality of first light sources disposed to the right side of the handlebar are illuminated, while a turning operation to the left results in one or a plurality of third light sources disposed on the left side of the handlebar to be illuminated, thus serving to illuminate the anticipated direction of the bicycle during a turn. While moving forward in a straight line, one or a plurality of second light sources maintains a constant forward illumination.

Also disclosed herein, alternatively, or in combination with a first plurality of horizontally configured lights, is a second set or plurality of light sources configured in a vertical orientation and located at or near the midpoint of the handlebars or on the handlebar riser of a bicycle that may be employed to provide controlled illumination of the bicycle's forward path, by means of a sensor capable of detecting the relative vertical orientation of the bicycle and which communicates this position to a microcomputer which then activates one or a plurality of the vertically oriented light sources to provide illumination in response to the bicycle's vertical orientation.

Disclosed herein is one or a plurality of sensors capable of responding to the bicycle's relative forward motion and which communicates any abrupt slowing or braking of the bicycle to a microcomputer which then selectively activates one or a plurality of rearward facing lighting units to provide a braking signal to observers located behind the bicycle.

Disclosed herein is a microcomputer or a microcontroller associated with one or more sensors capable of measuring the relative position of the handlebars (rotation), vertical and horizontal orientation of the bicycle, momentum, speed or other instantaneous parameters associated with the motion of a bicycle and communicating one or more of these parameters to a microcomputer for analysis, the microcomputer subsequently using the supplied parameters to control the illumination and intensity of one or a plurality of forward and rearward facing lighting units and directional signal lighting units located on the frame of a bicycle.

In one embodiment, a microcomputer disposed on or in the handlebar, or on the handlebar riser, is coupled to a first set of light sources and a second set of light sources, and a rotation sensor or gauge. The rotation sensor is operable to sense movement of the handlebar relative to the frame and control the activation of the first and second set of light sources so as to provide illumination in response to the position of the rotation sensor. In operation, as a bicycle rider turns the handlebars, the light sources would be selectively activated to illuminate the path in the direction of travel.

Various embodiments may provide for illuminating both the direction of impending travel and the direction of current travel, so that one or more lighting units remain continuously activated and one or more variable lighting units are selectively activated by the microcomputer when needed depending on the relative motion, position and orientation of the bicycle. Some embodiments may employ solar charging, and/or detection of on-coming light to change to a normal low beam from a high beam. Additional embodiments may employ a light sensor to adjust the intensity of the lighting units in response to the ambient or background lighting, increasing the relative intensity during the day and decreasing the relative intensity during dusk or dark periods of the day, or open entry to a darkened area such as a tunnel or shaded bike path, in order to increase contrast of the lighting units for improved visibility.

In one exemplary embodiment, the sensor detects the relative vertical orientation of the bicycle and communicates this to the microcomputer which selectively activates one or a plurality of lighting units configured in a vertical orientation and located at or near the handlebar or handlebar riser of the bicycle in order to illuminate the forward path of the bicycle during a rise or descent from a horizontal plane, such as for example when climbing or descending a hill, respectively. In other embodiments, a turn of the bicycle to the right or left results in the activation of lights acting as turn signals. Manual activation of the desired turn signals is also contemplated in other embodiments of the present invention.

### BRIEF DESCRIPTION OF DRAWINGS

FIG. 1 shows a bicycle with various mounting zones or positions capable of accommodating an inventive lighting device as disclosed herein.

FIG. 2 shows two embodiments of a lighting device configured in a horizontal position and mounted to the handlebar region of a bicycle.

FIG. 3 shows an embodiment of a lighting device configured in both a horizontal and a vertical position and mounted to the handlebar region of a bicycle.

FIG. 4 shows another embodiment of a lighting device configured in both a horizontal and a vertical position and mounted to the handlebar region of a bicycle.

FIG. 5 shows a block diagram representation of a microcomputer control unit capable of operating the lighting units of the present invention.

FIG. 6 shows two embodiments of a vertically-positionable lighting unit comprised of three individual LED illumination modules.

FIG. 7 shows an illustrative example of a lighting pattern controlled by a microcomputer in response to the relative vertical orientation of the bicycle with respect to a flat or horizontal reference plane.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example, and without limitation, in cases in which a measure or value is “relatively increased” or “relatively more”, that comparison need not be with respect to any known measure or value but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

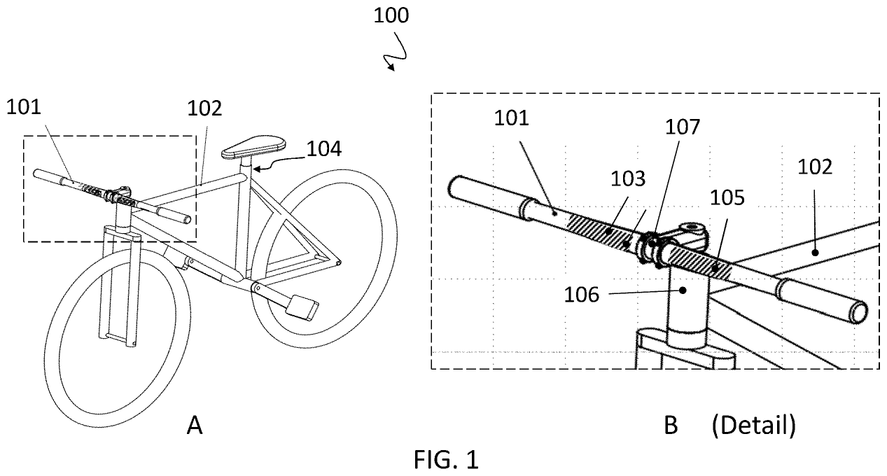

FIG. 1 shows an illustration of a typical bicycle 100 in perspective view in panel A, with a handlebar portion 101 that is generally configured in a horizontal manner, having a right and left side featuring open areas that may serve as a right mounting area 103 and a left mounting area 104 for the present inventive devices, as shown expanded in a second detail panel B. In addition, the bicycle features a top bar section 102, which may be straight in the case of a “man's” bike or curved in the case of a “women's” bike, upon which one or more modules of the inventive device may also be installed. Further, the bicycle features a seat post mounting area 104 to which a rear portion of the inventive device may be attached, as well as a front wheel riser portion 106 which features a center mounting area 107 which can also accommodate one or more modules associated with one or more embodiments of the inventive device as disclosed herein.

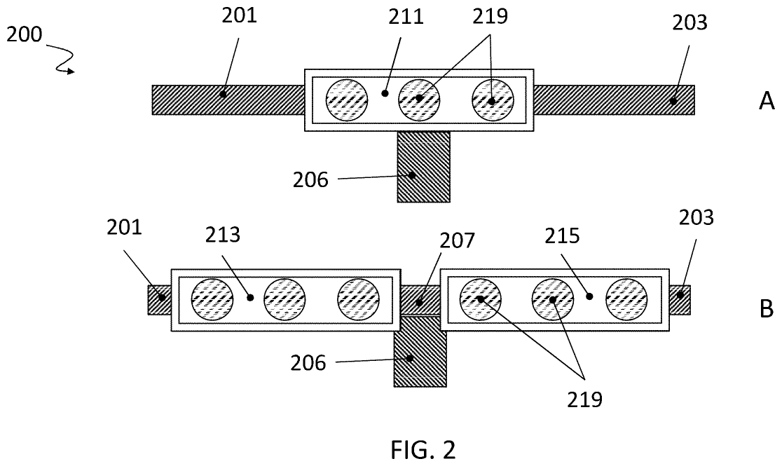

FIG. 2 shows a front view of the handlebar section of a bicycle 200 with a single centrally mounted bike light module 211 in panel A and a set of mounted bike light modules 213 and 215 in panel B. The single centrally mounted bike light module 211 may be attached to either the right handlebar area 201, the left handlebar area 203 or the front wheel riser portion 206, or the center yoke mounting position 207 (seen in panel B) or a combination thereof, so that the LED lenses 219 of the light modules face in the forward direction with respect to the bicycle, and are fixed in position on the handlebar or a moveable portion of the riser or center yoke so as to remain fixedly oriented with respect to the handlebars, 201 and 203 of the bicycle. In the second embodiment shown in panel B, a first or right bike light module 213 is mounted to the right handlebar area 201 and a second or left bike light module 215 is mounted to the left handlebar area 203, so that the plurality of LED lenses 219 of the light modules 213 and 215 face in a forward direction with respect to the bicycle. Accordingly, in these two embodiments, panel A shows a single light module with a plurality of three LEDs and LED lenses (219) to disperse light emanating from the LEDs when they are activated, while panel B shows two light modules each with a plurality of three LEDs and their respective LED lenses (219). In alternative embodiments, at least two LEDs, positioned in a right and left configuration, or a plurality of four or more LEDs, positioned with an equal number of LEDs on the right and left side of the midpoint of the handlebar assembly are contemplated by the present invention. In yet another alternative embodiment, at least one single forward-facing light module may be included that is centrally located on the handlebar at the position of the riser 206 or yoke portion 207 of the riser.

In yet further embodiments, the light modules 211, 213 and 215 may be incorporated into the respective handlebar portions, rather than mounted to their exterior. In these embodiments, the handlebar may be made with a variety of materials, but not limited to, aluminum, steel, stainless steel, metal, wood, carbon fiber, or plastic and any combination of those. The handlebars 201 and 203 can be treated, but not limited to, painted, anodized, electro-plated, sandblasted, bead-blasted, or any combination thereof. The handlebar can house two light assemblies 213 and 215, for example on the right and left sides, respectively. Alternatively, a single handlebar section can house a single light assembly 211 located near the center point or yoke portion 207 of the bicycle handle. In one embodiment, the LED light sources are located within mountable lighting assemblies such as 211, featuring an LED lens to disperse the light emanating from the LED source in a favorable pattern, such as cone or half-cone pattern capable of illuminating an area in front of the bicycle without excess light being directed upward into the view of oncoming vehicles, or people or objects in front of the bicycle. In an alternative embodiment, the light sources are contained inside the bar or in cavities in the bar in order to reduce the protrusion of the lights, giving a smaller envelope size and reducing aerodynamic drag during use. In alternative embodiments, the light sources 219 may be incandescent lights, light emitting diodes (LEDs), halogen, fluorescent, or other suitable sources of illumination able to provide adequate illumination of the road surface or to provide signal indication for those employed as turn signals or as brake lights. Alternatively, or additionally, the system could have alternative lights pointed to the right side or the left side of the bicycle with respect to its center line or angled away from the main focus beam of a primary light or plurality of primary lights facing in a forward direction. There can be one light module 211, providing one light each for left and right sides with a center light, or a multiple array of lights, such as left and right lighting modules, 213 and 215, for left and right side of the bicycle handlebar.

In embodiments (not shown) in which the lighting modules are embedded in the handlebar portions, the lenses 219 associated with each light source may be shaped a certain way to allow the most projected area for light dispersion while minimizing the handlebar envelope to reduce wind resistance. The handlebar cutouts accommodating such embedded lighting modules are constrained by the handlebar stem mount, brake levers, gear shifters and grip handles also located on the handlebar portion of the bicycle. In related inventive embodiments, the handlebar cutouts are sized in width and height to maximize light dispersion while allowing for sufficient stiffness and strength of the handlebar under user load. In further related inventive embodiments, the lenses 219 can be curved in one or two directions, or alternatively designed to be flush with the curvature of the handlebars themselves. The lenses can be plastic or glass or any transparent or light transmitting material, or alternatively, the lenses can also be frost treated to act to diffuse the light emitting from the handlebar.

The yoke portion 207 clamps the handlebar 201 and 203 in a rigid fashion with respect to the riser 206 and can serve as an alternative mounting area for one or more of the lighting modules 211 or sensors associated with the inventive device, as discussed in more detail below.

In yet another inventive alternative, a second lighting module 211 can be mounted on the rear of the bicycle, for example to the seat post 104 or to the seat assembly itself or to the triangular region immediately below the seat post riser, so as to face in a backwards direction to provide illumination behind the bicycle. In one embodiment, the center light of a ternary set of lights as shown in lighting module 211 can serve as a running light, while the right and left set of lights can serve as directional signals to indicate an upcoming right or left turn of the bicycle, or motion of the bicycle to the right or left, respectively. In yet another embodiment, the combined lights of the lighting module 211 can all be simultaneously activated to indicate a braking action or dramatic slowing of the bicycle to provide notice to an observer behind the bike, such as another cyclist or driver of a motor vehicle.

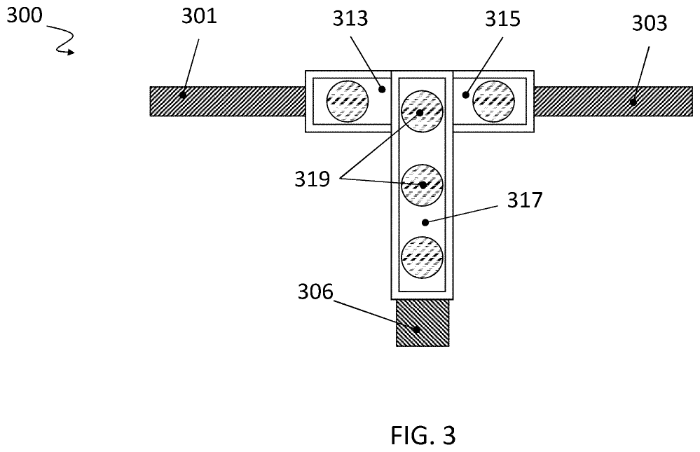

FIG. 3 shows an alternative embodiment 300 of the present invention featuring a plurality of mounted bike light modules, 313, 315 and 317, mounted to either the right handlebar 301, the left handlebar 303, the front wheel riser portion 306, or a combination thereof, so as to remain fixedly positioned and facing in a substantially forward direction with respect to the bicycle frame. Here, the right bike light module 313 features a single light source, such as an LED with a corresponding LED lens 319, a left bike light module 315 also featuring a single light source with a corresponding LED lens 319, and a vertically oriented center bike light module 317 with a plurality of three light sources each with associated LED lenses 319.

In one embodiment, only the top center light source located in lighting module 317 is illuminated during the normal forward movement or operation of the bicycle. When the handlebars of the bicycle are turned to the right, the inventive device may activate the right light source 313 in order to illuminate the front right anticipated path of the bicycle. Conversely, when the handlebars of the bicycle are turned to the left, the inventive device may activate the left light source 315 in order to illuminate the front left anticipated path of the bicycle. In these two example embodiments, the top light of the center bike light module 317 may either remain illuminated or be switched off when the corresponding right or left lighting modules are activated. In yet another embodiment, all the topmost lights, including 313, 315 and the top light of lighting module 317 may be activated to produce “high beams” for maximum lighting effect.

In another embodiment, the lights of the center bike light module 317 are selectively activated in response to the inclination of declination of the bicycle with respect to the horizontal. For example, when the bicycle is moving along a flat horizontal surface, only the middle light of module 317 is activated in one embodiment, while the top light is activated when the bicycle is in a declined position such as moving downhill, or alternatively only the bottom light is activated when the bicycle is in an inclined position such as when moving uphill. These and other related embodiments are described in more detail below in regard to sensors and a microcomputer or microcontroller capable of detecting the inclination or declination of a bicycle with respect to the horizontal and selectively activating one or a plurality of the lights associated with the lighting modules as desired.

As described hereinabove with other embodiments, the lighting modules may also be positioned internally to the riser portion of the bicycle, although this is more difficult owing to the current design of the riser portions, which also need to accommodate space for the tube supporting the front wheel and internal screws normally used to secure the riser and the handlebars of a bicycle via the yoke. In one preferred embodiment, the center bike light module 317 is secured externally to either the riser portion, the yoke, or to either the right or left handlebar mounting area so that it is appropriately positioned in a forward facing direction and moves with the handlebars.

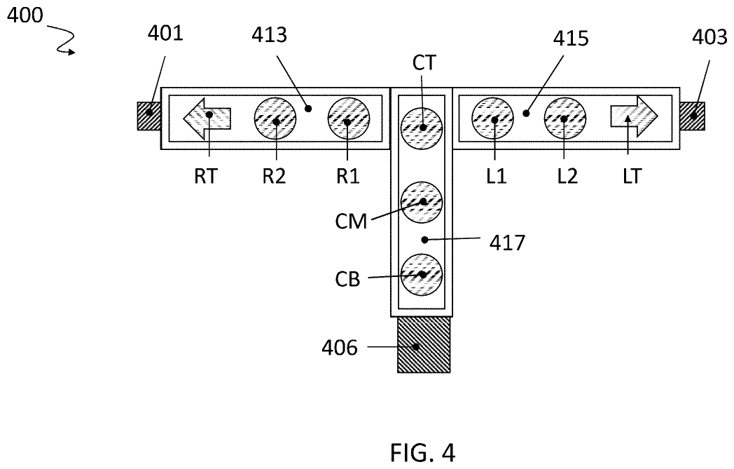

FIG. 4 shows yet another inventive embodiment 400 of the present invention featuring three lighting modules, a right bike light module 413 mounted to a right handlebar area 401, a left bike light module 415 mounted to a left handlebar area 403, and a center bike light module 417 mounted to the front wheel riser portion 406. Alternatively, one or more of the lighting modules may be mounted to either the right or left handlebar areas, 401 or 403, or to the front wheel riser portion 406 if they are attached to one another as a single unit or combination of two lighting units, or in any suitable configuration to secure their position on the bicycle and their position relative to one another as shown in the illustration in FIG. 4. In the embodiment shown, the rightmost light source or LED of the right bike light module 413 is fitted with a directional signal lens (RT) in the shape of an arrow pointing to the right, while the leftmost light source or LED of the left bike light module 415 is fitted with a directional signal lens (LT) in the shape of an arrow pointing to the left. During use, the microcomputer or microcontroller of the inventive device may selectively activate either the rightmost light or the leftmost light of the respective lighting modules to indicate an upcoming desired right turn or left turn of the bicycle, respectively, in order to provide a turn signal to any observers located in front of the bicycle or located within its forward path of motion, prior to the making of a turn.

In one inventive embodiment, the outer lights of the right (R2) and left (L2) bike light modules 413 and 415 may also be selectively activated during the actual turning of the bicycle to provide illumination in the desired direction of travel or activated manually by the bicycle rider prior to an anticipated turn to alert observers. In yet another inventive embodiment, the remaining lights of the right (R1) and left (L1) bike light modules 413 and 415 may also be selectively activated in combination with the activation of the desired turn signal to further emphasize or draw attention to the upcoming turn event, such as for example illuminating them briefly or at a lower illumination level than for typical driving lights, or alternatively activating them sequentially in the direction of the desired turn to emphasize the anticipated turning of the bicycle in that direction, such as activation of L1, then L2, then LT in sequence to indicate a left turn, and conversely activation of R1, then R2 and then RT to indicate a right turn. In yet another related embodiment, the lights, LEDs or lenses 419 of the turn signal lights may be colored yellow or red (or any color other than white) to distinguish them from the other lights so that the turn signal is more readily perceivable. In another related embodiment, a microcomputer also activates rearward facing turn signals, so that upon a manual or automatic activation of the turn signals, both the corresponding front and back turn signals are activated prior to or during an anticipated or actual right or left turn event.

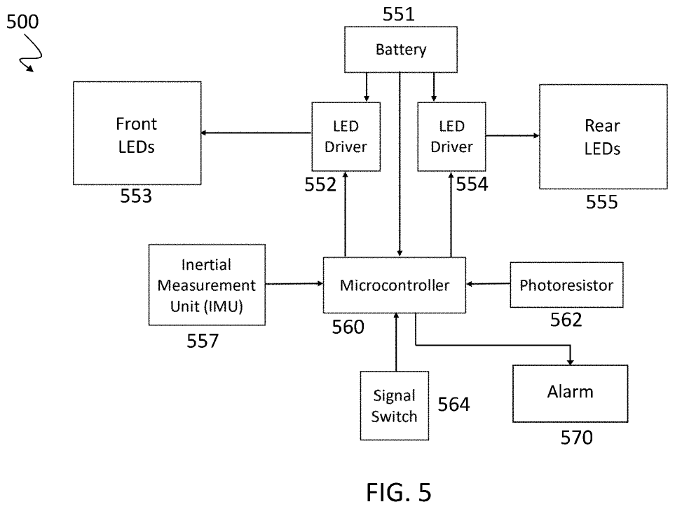

FIG. 5 shows one inventive embodiment of a control diagram represented in functional block configuration that is capable of actively sensing bicycle operational parameters and driving (activating) the appropriate lighting modules attached to or integrated into the bicycle, in order to provide adaptable bicycle lighting, wherein such lighting is selected from running lights, headlights (low beams, intermediate and high beams), taillights, turn signal lights, operational status lights, alarm lights, and combinations thereof.

In FIG. 5, the control circuit 500 includes a central microcomputer or microcontroller module 560, which receives power from a battery 551, input signals from a signal switch 564, positional input signals from an inertial measurement unit (IMU) 557 and input from a photoresistor 562. IMUs sense roll, pitch, and yaw of a device. Higher degree of freedom IMUs are conventionally available as well such as TDK's nine-axis model MPU-9250 motion tracking device. The microcontroller module 560 in turn processes these various signal inputs from the other components, and using embedded hardware and programmed software algorithms, generates various output signals that are relayed to a first LED driver 552 and a second LED driver 554. The first and second LED driver modules 552 and 554 then activate the desired front lights or front LEDs 553 and rear lights or rear LEDs 555 in an appropriate manner in response to the plurality of input signals provided to the microcontroller 560 from units 557, 562 and 564. In general, the microcontroller operates at some selected clock speed expressed in bytes per minute (BPS) to process the input signals, perform the desired calculations, and then generate corresponding output signals to the two LED driver modules. In preferred embodiments, the selected clock speed of the microcontroller 560 is sufficiently fast so that the response of the overall control circuit 500 can adequately react to changing input parameters and drive the corresponding desired lights or LEDs essentially in “real time” so that the system can react to changes in the bicycle's speed, vertical and horizontal orientation, movement, acceleration, deacceleration, turning and braking maneuvers, and then provide the desired corresponding visual output to observers by means of one or a plurality of lighting units without any undo delay to communicate the status of the bicycle. In some embodiments audio indications may be effectuated to control a speaker to pronounce human-understandable phrases such as “turning left”, “turning right,” and the like. This may be effectuated using pre-programmed audio commands played through a audio transducer such as a speaker. Microcomputers and microcontrollers available at this time can operate at sufficient speeds so that a plurality of calculations may be performed, and the desired lights or LEDs activated accordingly to meet or exceed an average 190 millisecond (0.19 second) delay associated with human visual perception of a change in lighting conditions. This well exceeds the typical human factor automotive driver response time of 1.5 seconds related to an adult driver operating a vehicle at a speed of 35 miles per hour (mph).

In one inventive embodiment, the bicycle rider can activate the signal switch 564 to signal either an anticipated right turn or left turn of the bicycle. An activating switch (not shown) or a pair of switches or push buttons located on the bicycle or on one of the inventive lighting modules is pressed by the bicycle rider to provide a signal from 564 to the microcontroller 560, which in turn activates the appropriate light or LED located on the front, rear or both ends of the bicycle to provide a turn signal notice to an observer. In a related embodiment, the signal switch 564 can operate in an automatic manner to detect movement to the left or right in association with the IMU 557 unit and send a corresponding “right turn” or “left turn” signal to the microcontroller 560 which then activates the corresponding LED drivers 552 and 554 to activate the corresponding right and left turn signal lights located on the front, rear or both ends of the bicycle.

During normal cycling on a relatively flat surface such as a road or bike path, the microcontroller 560 may be programmed to activate the corresponding LED drivers in order to provide front headlights and optionally rear running lights. Using the inventive embodiment shown in FIG. 4 as a non-limiting example, the microcontroller 560 may activate forward facing LED CT, or in combination with CM, and CB to function as headlights for the bicycle to illuminate the path forward. Alternately, the microcontroller 560 may activate all the horizontal LEDs (R2, R1, CT, L1, L2) for the purpose of generating “high beams” for providing a greater degree of illumination. Alternatively, the microcontroller 560 may activate a subset of the horizontal LEDs, for example only R1, CT and L1 for the purpose of generating “intermediate beams” for providing a slightly lesser degree of illumination. Alternatively, the microcontroller 560 may activate for example only CT for the purpose of generating a “low beam” for providing the lowest degree of illumination of the path forward. In related embodiments, the photoresistor 562 can be used to input the status of ambient light conditions to enable the microcontroller 560 to adjust the intensity of any one or combination of the LEDs, so that for example, any activated LEDs are brighter during daylight conditions for better visibility but are dimmed appropriately during dusk or nighttime conditions to avoid being too bright to oncoming traffic or observers. In one embodiment, the photoresistor 562 may sense the light from oncoming vehicles and this signal used by the microcontroller 560 to temporarily dim any headlights currently activated at high or intermediate beam intensities, as a courtesy for oncoming traffic, and then restore the headlights to a desired intensity level to illuminate the path forward. In another related embodiment, the photoresistor 562 may sense ambient lighting conditions in order to provide a signal to the IMU 557 unit to control the intensity of any one or combination of lights or LEDs that are activated, such as for example, adjusting the intensity of rear running lights (not shown) in response to daylight and night time lighting conditions, or alternatively to adjust the intensity of the brake lights (not shown) or turn signal lights, RT and LT and any corresponding rear signal lights (not shown) that are also being driven and controlled by the LED driver module 554.

In a related embodiment, the microcontroller 560 may flash or sequence illuminate a subset of the lights of LEDs to improve visibility. For example, using the embodiment shown in FIG. 3, which does not feature dedicated right or left turn signal lights, the microcontroller 560 may activate the topmost LEDs of lighting unit 313, 317 and 315 in sequence for a brief period of illumination of each corresponding LED to provide notice of an anticipated left turn. Alternatively, to indicate an anticipated right turn, either in response to a manual signal or an automatic signal generated by the IMU 557 unit indicative of an impending right turn by the bicycle, the microcontroller 560 may flash the topmost LEDs in the order of 315, 317 and 313 in sequence to provide notice of an anticipated right turn by the bicycle. In these particular examples, the corresponding LEDs would be briefly illuminated in the desired sequence to communicate a directionality, such as in sequential blinking to the right in that order of progression, or to the left in that order of progression. Further embodiments would include the nuance of slightly overlapping the illumination periods of the desired LEDs to produce the illusion of the lights moving in a right or left direction in order to enhance the perception and communication to an observer of an anticipated right or left turn by the bicycle, either in response to a manual signal from 564 or an automatic signal enabled by 564 but provided by the IMU 557 unit sensing a deliberate movement of the bicycle to the right or left, respectively.

In another related embodiment, the IMU 557 unit may detect a sharp deacceleration in the movement of the bicycle and provide a corresponding input signal to the microcontroller 560 which in turn may activate the corresponding LED drivers associated with the rearward facing lights or LEDs, enabling them to act as “brake lights” to warn any cars, bicycles or other observers following the bicycle of its slowing or braking action. In a related embodiment, the IMU 557 unit's output signal may be proportional to the deacceleration force, so as to provide a relative input intensity or signal to the microcontroller 560 to adjust the intensity of the corresponding brake lights to indicate the degree of deacceleration. For example, with very mild braking or deacceleration associated with the normal variations in speed from pedaling the bicycle, the microcontroller 560 would not activate the brake lights, while with some braking or some deacceleration the microcontroller 560 would activate the brake lights at a minimum intensity, and with a greater degree of braking or greater deacceleration the microcontroller 560 would activate the brake lights at a maximum intensity. In a related embodiment, if the IMU 557 unit detects any acceleration, it would provide a corresponding signal to the microcontroller 560 to turn off the brake lights, or alternatively if the IMU 557 detects a reduction in the deacceleration, it would provide a corresponding signal to the microcontroller 560 to dim the brake lights.

In yet another related embodiment, the signal switch 564 could also accommodate manual input from either one of the front or rear brake levers, for example by means of a switch or sensor associated with the lever or a moving portion of either the front or rear braking system, in order to generate a braking signal communicated to the microcontroller 560, which in turn may drive the corresponding rear LED driver 554 to activate the brake lights in response to manual operation of either the front or rear brakes or combination of the two. In a further embodiment, activation of only one brake may generate a first signal by signal switch 564 communicated to microcontroller 560 to drive the rear LEDs as brake lights at a first or low intensity, while in contrast activation of both the front and rear brakes may generate a second signal by signal switch 564 resulting in the microcontroller 560 driving the rear LEDs as brake lights at a second or higher intensity to communicate a greater braking action by the operator of the bicycle.

The signal switch 564 can also be used to turn the control system 500 on or off, or to set modes of operation. In embodiments in which the signal switch 564 is used to set modes, these may include modes for daytime operation, nighttime operation or automatic sensing of ambient lighting conditions to program the microcontroller 560 to respond accordingly. In another related embodiment, the signal switch 564 may be set in “alarm” mode, so that when the bicycle is not in use, or has been parked temporarily between authorized uses, the system will detect any motion of the bicycle and activate selected lights and optionally an audible alarm to indicate unauthorized motion of the bicycle. In some embodiments, the audible alarm may include voice-like capabilities to signal the bike is being stolen. In yet another inventive embodiment, the signal switch may select the “terrain” or riding conditions of the bicycle, such as for example, riding the bicycle under a street mode, stunt mode, mountain bike mode, racing mode, etc.

Using the inventive embodiment shown in FIG. 4 as a non-limiting example, the microcontroller 560 may activate the RT LED in response to a right turn signal being activated by the signal switch 564 in response to a manual signal by the bicycle operator in anticipation of an upcoming right turn, or alternatively activate the LT LED in response to a left turn signal being manually activated by the signal switch 564 in response to a manual signal by the bicycle operator in anticipation of an upcoming left turn. In a related embodiment, corresponding rear right and left turn signals (not shown) may simultaneously be activated in concert with the front right and left turn signals, respectively. In yet another related embodiment, the signal switch 564 can be used to indicate automatic turn signal generation, enabling the microcontroller 560 to receive inertial motion signals from the IMU 557 unit to generate a right turn signal or a left turn signal if the IMU 557 unit detects a sudden movement of the bicycle to the right or to the left, respectively, with respect to the forward direction of travel.

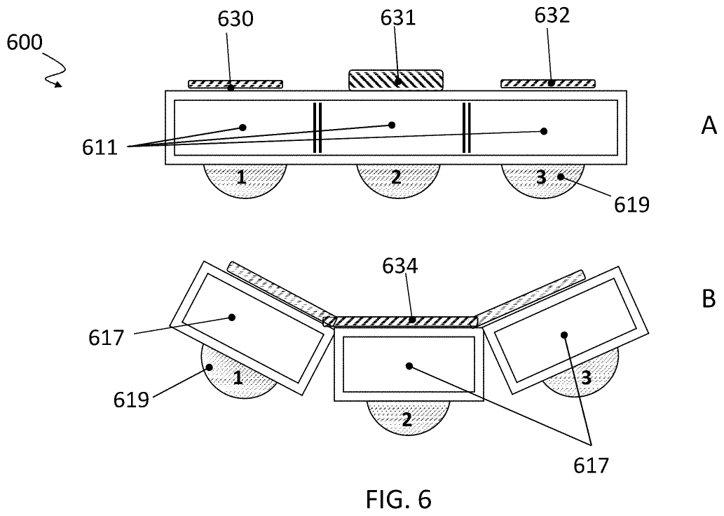

In a related inventive embodiment as shown in FIG. 6, front center bike lights 600 may be used, configured either in a linear or flat array of multiple lighting units 611 as shown in panel A or in an angled array of angled lighting units 617 as shown in panel B, mounted on or near the handlebar portion of the bicycle and facing substantially forward. In yet another embodiment (not shown), the 619 lenses 1, 2 and 3 of the linear or flat array of multiple lighting units 611 may be selectively angled or designed to project a cone of light in an angled fashion, as opposed to straight forward, in order to achieve the same lighting pattern as that obtained from the angled lighting array 617 shown in panel B. Depending on the position and geometry of the handlebars and to which portion of the handlebar the center bike lights 600 are attached, one may use either one of the mounting positions shown (630, 631 or 632) to attach to a center position on the handlebar or to the handlebar riser or yoke as disclosed herein. Alternatively, in the example inventive embodiment using an angled center bike light as shown in panel B, the unit can be attached by means of an angled bracket 634 to either the front handlebar riser or the yoke portion of the bicycle, or alternatively to either the right or left side of the handlebar immediately adjacent to a center position near the handlebar riser or yoke portion, so as to be positioned relatively close to the centerline of the bicycle and facing substantially in a forward direction.

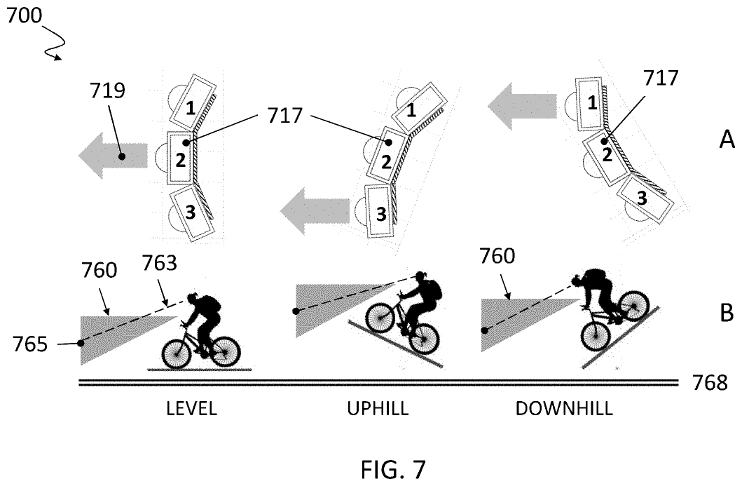

The example lighting modules shown in FIG. 6 are controlled by the control circuit 500 in response to the IMU 556 unit's detection of an inclination or declination in the position of the bicycle during operation with respect to a horizontal reference plane or flat surface. Using the example illustrations shown in FIG. 7 for an angle-styled lighting module corresponding to 617 (see FIG. 6), the IMU 556 will control the front LED driver 552 module to selectively activate the desired lights or LEDs in the lighting unit 617 in response to the inclination/declination of the bicycle. For example, when the bicycle is moving forward in a relatively level orientation as shown on the left side of panel B of FIG. 7, the center light or LED #2 of the angled light module 717 is selectively activated by the microcomputer 560 via the LED driver 552 to create a cone of illumination 760 that points substantially straight ahead (in the direction of travel) and optionally slightly downward along the bicycle riders line of sight (indicated by the dotted line 763), in anticipation that the rider will require focusing on or near a point 765 in the direction of travel that the bicycle will soon traverse, in order to see and anticipate any obstacles in the path forward. Alternatively, when the bicycle approaches an incline or starts moving in an uphill direction, as shown by the center illustration in panel B, the microcomputer 560 receives a signal from the IMU 557 unit indicative of a change in inclination, prompting 560 to send a corresponding signal to the LED driver 552 to activate the lower light or LED #3 in order to maintain a relatively horizontal projection of a cone of illumination in response. Here, activation of the lower light or LED #3 maintains illumination in a cone along the sightline 763 of the uphill riding bicyclist, who will preferentially be looking at a focal point much closer to the front of the bicycle as a result of moving uphill. Alternatively, when the bicycle approaches a decline or starts moving in a downhill direction, as shown by the rightmost illustration in panel B, the microcomputer 560 receives a signal from the IMU 557 unit indicative of a change in inclination, prompting 560 to send a corresponding signal to the LED driver 552 to activate the upper light or LED #1 in order to maintain a relatively horizontal projection of a cone of illumination in response. Here, activation of the upper light or LED #1 maintains illumination in a cone along the sightline 763 of the downhill riding bicyclist, who will preferentially be looking at a focal point much further ahead from the front of the bicycle as a result of moving downhill. In some embodiments, when a downhill slope is sensed, the illumination may be splayed further down and brighter to provide for better ground coverage. In other related embodiments, depending on the degree of inclination or declination, a subset of two of the lights or LEDs may be activated to provide substantially overlapping cones of illumination for increased visibility. In another related embodiment, the IMU 557 unit may be programmed to respond to a particular terrain selection, so as for example, when set to “mountain bike” status or “rough terrain” status, the IMU 557 applies a delay factor or integrative response when activating one or a plurality of the lighting units or LEDs to prevent needless activation or strobing of the lights with minor changes in inclination or declination as when the bicycle passes over a rock, dip or other minor change from the horizontal. In another embodiment, the signal switch 564 may be set to a “full illumination” mode, so that during operation of the bicycle, all available forward facing lighting units of LEDs are activated and remain illuminated regardless of bicycle movement, orientation or inclination/declination.

In another inventive embodiment, the signal switch 564 may be set to an “alarm” mode, so that after the bicycle is parked, any movement detected by the IMU 557 units results in the microcontroller 560 activating an optional alarm module 570, which may include a siren, buzzer, loudspeaker or other noise-generating device recognizable as an audible alarm to an observer, to indicate the potential tampering or attempted theft of the bicycle. In a related embodiment, the IMU 557 may also, when detecting an alarm mode, activate one or a plurality of the lighting units or LEDs, either in a continuous or intermittent flashing mode to provide an additional visual cue to an observer. In yet a further related embodiment, the alarm module 570 may also include a means of communication, such as via Bluetooth™, radiofrequency (RF) or Wi-Fi, to alert the owner or user of the bicycle of the alarm being triggered.

The present disclosure anticipates the combination of any one or more of the highlighted embodiments disclosed herein, as well as other embodiments suggested by the disclosure.

### Components

The control circuit 500 is preferentially located within a waterproof housing 580 (not shown) to shield it from dust, dirt, water and rain, for example. Further, any components external to the control circuit housing 580 are also located within respective waterproof housings to protect the lights and LEDs, sensors, and other components from dust, dirt, water and rain, for example. The entire inventive device including control circuit 500, sensors and lights can be located within one housing, or distributed amongst different housings, such as for example a first, front mounted housing unit attached to the handlebars and a second, rear mounted housing unit attached to the seat post or suitable rear portion of the bicycle. For embodiments employing separated units, the units may be connected or communicate between themselves by means of a physical wire, such as one or more electrical wires, by means of the metallic bicycle frame for electronic impulse or impedance signals, or by remote communication using Bluetooth™, RF (radio frequency, AM or FM modulated) and Wi-Fi signals, and combinations thereof. In other embodiments, a front and rear device may be employed that act independently of one another to provide identical or separate functions, for example the front control unit providing front lighting and directional signal control, while a rear control unit provides rear lighting, directional signal and brake light control.

The inertial measurement units (IMU) can be any commercially available unit that can detect any one or combination of movement, orientation, inclination, declination, velocity, acceleration, deacceleration or some combinations thereof, of the bicycle, either at rest or in motion. One non-limiting example is the InvenSense IMU, model number MPU 9250, which is a nine-axis combined gyrometer, accelerometer and compass, available from the TDK Corporation of America, 455 RXR Plaza, Uniondale, N.Y. 11556, U.S.A. This particular IMU is a System in Package (SiP) module that combines two chips: the MPU-6500, which contains a 3-axis gyroscope, a 3-axis accelerometer, and an onboard Digital Motion Processor™ (DMP™) capable of processing complex MotionFusion algorithms; and the AK8963, the market leading 3-axis digital compass, and capable of providing output signals to the inventive microcontroller of the present invention for the purpose of activating the appropriate lights or LEDs in response to different motions and movements of the bicycle to which the inventive device is attached. This particular IMU unit, and others having similar features acceptable for use with embodiments of the present invention, features an electronic compass that can detect and communicate (via an output signal) the relative orientation of the bicycle during motion, and further features a 3-axis accelerometer that can detect and communicate relative acceleration in the X, Y and Z spatial dimensions, and further features a 3-axis gyroscope that can detect and communicate relative changes in orientation including yaw, roll and pitch. A yaw rotation is a movement around the yaw axis (vertical) of the bicycle in response to the direction it is pointing, being either to the left or right of its direction of motion. A roll rotation is a rotation around the front-to-back axis (horizontal) of the bicycle in response to the leaning of the bicycle to the right or left with respect to its direction of motion. A pitch rotation is a rotation about the center axis of the bicycle in response to a change in the inclination of the bicycle with respect to a horizontal reference or the ground. By interpreting the corresponding output signals and their intensities from a IMU unit, the microcontroller can determine the relative values of the nine spatial and movement vectors of the bicycle in order to calculate and drive the respective LED drivers to control the lights or LEDs of the inventive device to provide interactive signaling and lighting effects beneficial to the operator of the bicycle. For example, yaw and roll can primarily be used to detect and provide a signal indicative or a right or left movement of the bicycle, or leaning of the bicycle to the right or left, respectively. Pitch can primarily be used to detect inclination or declination of the bicycle to detect whether it is going uphill, downhill or moving in a relatively flat or horizontal manner with respect to a level or horizontal reference. The 3-axis accelerometer can detect acceleration and deacceleration in any one of the X, Y, and Z directions, or combination thereof, and can primarily be used to detect increases or decreases in the speed or velocity of the bicycle while moving in a forward direction, or backward directions, in embodiments in which backup lights are included in the inventive control system.

The lights used in the light modules 553 and 555 may be selected from incandescent lights, xenon lights, LEDs (light emitting diodes), any suitable and commercially available light, or combinations thereof. The lights may be in contact with a thermal heat-sink to dissipate the local heat generated by the lights. The heat-sinks can be made of metal such as steel or aluminum or ceramic material. In one embodiment, the light assemblies preferably emit light in a dispersed cone shape for improved lighting effects and visibility. In another embodiment, the light assemblies preferably emit light in an omnidirectional pattern for improved lighting effects and visibility.

The control circuit 500's battery 551 can be rechargeable such as lithium iron phosphate, lithium ion, lithium metal, lead acid, nickel metal hydride, or non-rechargeable such as an alkaline cell. The batteries can be any combination of series and parallel from one to ten batteries in the module. The battery 551 may be charged through a charge port 552 (not shown) which may be a USB (universal serial bus), DC (direct current), or AC (alternating current) adaptable, and has a protective cover enabling easy replacement, if necessary. The battery cover may also feature a solar panel (554, not shown) to recharge the battery when exposed to ambient light or solar radiation. In another embodiment there can be an option to include a remotely located solar cell or panel so in case a rider forgets to charge the USB and is riding at night the system will have sufficient power. If the battery dies, the solar panel or cell may provide power to the inventive system. Also, the photoresistor 562 may pick up the night style riding and automatically turn the respective lighting modules on only when the environment gets dark to preserve battery power. Also, the system may turn on with small switches and have different mode settings and color changes if a rider wants. In embodiments including an alarm function, a lockable key-style or input pad control unit can be used to turn the inventive system on and off, to prevent someone from deactivating the alarm if triggered by an attempt to move or steal the bicycle when the proper owner or user has placed the controller into an alarm state.

On the front facing screen or primary light module of the inventive device there can be an arrow for left and right turn signals that are unlit during normal riding and that can only be activated to flash either left or right when the rider is riding for example, and taps either a turn signal switch or button, or briefly activates the left or right brake lever (without actually engaging the brakes) so that it is easy for riders to access when riding and wanting to generate right or left turn signal to warn an observer. When users “activate” a turn signal the corresponding light or LED, or LED with a lens in the shape of an arrow will illuminate or periodically flash either white, blue, red, green, (any desired color of the rainbow essentially) in the direction that they choose to hit the button (right or left), so that oncoming riders, pedestrians, cars, motorcycles will know that a bicycle is planning to move in that direction. Alternatively, the signal switch can be positioned to indicate an automatic response to either a quick right or left movement or leaning of the bicycle in a certain direction to activate the right or left turn signal lights, respectively.

The component parts will be adequately life tested to make sure that they will not fall apart, break, deteriorate, fog, fail etc. even after five years of use, for example. The internal electronics and components should be well supported and reinforced to the inner upper and lower edge of the handlebar inside, and not come loose or rattle during operation.

An example microcontroller or microcomputer 560 monitors output signals from the IMU 557 unit, the photoresistor 562, the battery 551 and the state of one or a plurality of user control signal switches 564 to control the lighting modules and manage power to the battery. The control circuit board may include the microcontroller, a processor, LED driver controls, power regulators or similar circuitry. The circuit board takes inputs from the internal and any external alternate sensors, performs an algorithm with embedded hardware and software, and outputs signals to the light modules. Power from the batteries 501 supports the system for the user to operate the inventive device and its various components and modules. The charger supplies energy to the battery module. A button or switch or key can turn the system on or off, or place into an automatic mode, and also change light modes. Many software algorithms are possible. In one embodiment the light will adjust to high beam or high intensity mode when there is no oncoming traffic or other sources of light from the opposite side of traffic, and as soon as the sensor detects oncoming lights then the microcontroller will dim or adjust the light modules to produce a normal low beam intensity, for example.

In another embodiment, alternate sensors may include a microphone for voice recognition features taking user voice commands as inputs and output behavior of the light modules including motion and brightness settings. In some embodiments, a programmable controller could reference common voice commands from local storage of voice characteristics. Voice commands may allow for changing to high beams, or for turn signal actuation.

In another embodiment, the software can have a road condition setting for example, “road, rocky or trail terrain” so that it automatically senses the riders riding pattern using software and hardware and adjusts the light modules illumination by reacting to the up/down movement and left/right movements of the bicycle as they vary with the road conditions experienced by the bicycle. In other words, the system detects, using on-board sensors such as accelerometers, the riding pattern and behavior and adjusts the output accordingly with hardware and software according to programmed routines, such as dampening an input from a pitch sensor to prevent too rapid of a change in forward lighting conditions that might produce an undesired pulsing or strobing effect that might disorient the rider without necessarily improving forward lighting of the terrain. In a related embodiment, the road condition status may include “street”, “mountain”, “racing”, “mixed” or other modes that enable the microcontroller to adapt to different riding conditions and adjust its programming and output correspondingly to enabling adaptive lighting conditions to be generated.

Other handlebar shapes besides a mountain bike style are possible and applicable. The road bike handlebar usually has less enclosed volume to fit the electronics and lights, compared to the mountain bike handlebar. Attachment of the integrated control unit with lighting modules or independent lighting modules can be varied to accommodate different handlebar configurations.

In another embodiment, the standard handlebar envelope is expanded to give more room for the light modules and/or control units when embedded within the handlebar itself. Many shapes of cavity or handlebar shapes are possible.

There can be various shape embodiments: mountain bike handlebar, road bike, kid bike, cruiser bicycle, tricycle, moped, electric bicycle, electric scooter (two or three wheeled) pedal scooter, skateboard, etc. Also, the technology can be embodied into virtually anything that moves, for example including mountain bikes (trail, electric, downhill, cross-country), BMX bikes, road bikes (performance, adventure and gravel, cyclocross, triathlon), fitness bikes (commute, speed, comfort), electric bicycles (mountain or street), strollers, jet skis, boats, surfboards, boogie boards, golf carts, skates, roller coasters, bumper cars, private planes, charter planes, snowboards, and the like.

The structure and techniques of present disclosure may, in some embodiments, include lights installed in pedals, the seat back, and on the rear frame (in the “rear triangle” portion) of a bicycle or on the seat riser portion of the bicycle frame beneath the seat back.

In another embodiment bicycle luminaire system may be effectuated with a plurality of LEDs disposed on the handlebars of the bicycle and further disposed to splay light in multiple pre-determined directions. An inertial measuring unit (IMU operable to detect changes in orientation in at least 3 degrees of freedom may be coupled to a processor which, in turn, is coupled to the LEDS. The processor then may receive an inertial movement signal from the IMU and control the light emitting diodes in response to the signal such that the processor controls the LEDs to splay light in the new direction of orientation.

In some embodiments the IMU may be disposed on a bicycle, whereas in others it may be disposed on the rider or the rider's helmet and coupled to the processor wirelessly.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A bicycle luminaire system including:
a plurality of light emitting diodes (LEDs), said LEDs disposed on the handlebars of the bicycle and further disposed to splay light in at least a first direction and a second direction;
an inertial measuring unit (IMU), said IMU operable to detect changes in orientation in at least 3 degrees of freedom;
a processor coupled to the IMU and the LEDs, said processor operable to receive an inertial movement information from the IMU and control the light emitting diodes in response to the input,
wherein the processor controls the LEDs to splay light in the different direction of orientation.

2. The system of claim 1 wherein the IMU is disposed on the bicycle.

3. The system of claim 1 wherein the IMU is disposed on a bicycle rider.

4. The system of claim 3 wherein the IMU is coupled to the processor wirelessly.

5. The system of claim 1 further including a plurality of second LEDs disposed substantially vertically on a front wheel riser of the bicycle.

6. The system of claim 5 wherein the first direction is yaw, the second direction is pitch, and the third direction is roll, and the control of the LEDs includes illuminating predetermined LEDs associated with either the yaw, pitch or roll of the IMU.

7. A method of illumination including:
disposing an array of LEDs to splay a cone of light both horizontally and vertically;
receiving, at a processing device, roll, yaw or pitch information from an IMU, said roll, yaw, or pitch information indicative of motion along an axis;
altering the splay of the cone of light from the array of LEDs in response the roll, yaw or pitch information,
wherein the splayed cone of light is more intensive in one portion of the axis as a result of the altering.

8. The method of claim 7 where each LED in the array of LEDs is disposed in a different direction.

9. The method of claim 7 wherein the arrays of LEDs are on a vehicle.

10. The method of claim 9 wherein the vehicle is a bicycle.

11. The method of claim 7 wherein the IMU includes at least one of a gyroscope, an accelerometer, or a compass.

12. The method of claim 7 wherein the IMU is wirelessly coupled to the processing device.

13. One or more processor-readable, non-transitory, storage devices encoded with instruction directing a processor perform a method including the steps of:
receiving roll, yaw or pitch information from an IMU, said roll, yaw, or pitch information indicative of motion along an axis;
altering the splay of a cone of light from an array of LEDs in response the roll, yaw or pitch information by controlling one or more LED drivers to increase illumination in the direction of a new orientation.

14. The method of claim 7 wherein the IMU includes at least one of a gyroscope, an accelerometer, or a compass.
